(19) United States
(12) Patent Application Publication
(10) Pub. No.: US 2026/0045020 A1
(43) Pub. Date: Feb. 12, 2026

(54) METHOD AND APPARATUS FOR GENERATING A REALISTIC AND ANIMATED FACIAL AVATAR OF A SUBJECT

(71) Applicant: SAMSUNG ELECTRONICS CO., LTD, Suwon-si (KR)

(72) Inventors: Sathish CHALASANI, Bangalore (IN); Ritaban Roy, Bangalore (IN); Sudeep Kumar Sahoo, Bangalore (IN); Kiran Nanjunda Iyer, Bangalore (IN); Krishna Chaitanya Velagapudi, Bangalore (IN)

(73) Assignee: SAMSUNG ELECTRONICS CO., LTD, Suwon-si (KR)

(21) Appl. No.: 19/291,233

(22) Filed: Aug. 5, 2025

Related U.S. Application Data
(63) Continuation of application No. PCT/KR2025/095465, filed on Jul. 22, 2025.

(30) Foreign Application Priority Data
Aug. 6, 2024 (IN) 202441059370

(51) Int. Cl. G06T 13/40; G06T 3/02; G06T 3/40; G06V 10/74; G06V 10/762; G06V 10/82; G06V 40/16

(52) U.S. Cl. CPC G06T 13/40; G06T 3/02; G06T 3/40; G06V 10/761; G06V 10/762; G06V 10/82; G06V 40/174

(57) ABSTRACT

A method of generating a facial avatar of a subject includes capturing, by a Head Mounting Display (HMD) device, a plurality of facial images of a subject wearing the HMD device in a plurality of predefined perspectives; generating, by the HMD device, perspective embedding vectors indicating a facial expression of the subject corresponding to each of the plurality of predefined perspectives; generating, by the HMD device from a pre-fed neutral facial image of the subject, neutral embedding feature vectors; generating, by the HMD device using an AI/ML based expression transfer model, a frontal facial image of the subject capturing the identity and the facial expressions of the subject based on a correlation of the perspective embedding vectors with the neutral embedding vectors; and performing, by the HMD device, Three-Dimensional (3D) morphing on the generated frontal facial image of the subject for generating the facial avatar of the subject.

### CROSS-REFERENCE TO RELATED APPLICATIONS

This application is a continuation of International Application No. PCT/KR2025/095465, which was filed on Jul. 22, 2025, which claims priority to Indian Patent Application number 202441059370, filed on Aug. 6, 2024, the disclosures of which are incorporated by reference herein their entirety.

### BACKGROUND

### 1. Field

The present disclosure relates, in general, to Augmented Reality and Virtual Reality Head Mounting Display (HMD) Devices. Particularly, the present disclosure relates to a method and apparatus for generating a realistic and animated facial avatar of a subject.

### 2. Description of Related Art

In recent years, Augmented Reality/Virtual Reality (AR/VR) Head Mounting Display Devices (HMDs) have gained popularity because of the ability of HMDs ability to provide immersive experience in a wide range of applications such as virtual video conferencing and VR gaming for a user to portray their expressions effortlessly without showcasing actual face of the user. However, there are still some limitations and challenges in achieving these features.

The conventional techniques are limited to either creating low resolution or unrealistic Three-Dimensional (3D) face or animated avatars of the user. There is a need for a hybrid solution that allows generation of both 3D face avatar and animated avatar for the user. Further, these conventional techniques fail to accurately represent a user's face as an avatar as the parameters present in a data utilized for training the avatar is limited. These parameters are limited due to the limitations of capturing a partial view of the user's face due to challenges associated with camera positioning that may be required to accurately capture the user's face. Based on the placement of the Head Mounted Device (HMD), the captured images may vary from user to user. Further, HMD also blocks the user's face which makes getting exact correspondences between the user's facial expressions and HMD captured images very challenging. Furthermore, most of the existing open-source and popular face asset datasets have extremely limited ethnic variations. Datasets representing different races and skin colors are almost non-existent due to complex data capture methodologies. Therefore, most of the conventional methods fail to generalize variations in face geometry and texture resulting in a less accurate representation of the facial avatar associated with the user. Further, Infrared (IR) cameras which are used for face tracking have a different style and distortions compared to normal RGB or grayscale images. Due to these limitations, for a face tracking method to work effectively, such domain gap between HMD perspective images and training data needs to be addressed.

Therefore, there is a need for an improvised method of generating a realistic and animated facial avatar of a subject.

The information disclosed in this background of the disclosure section is only for enhancement of understanding of the general background of the invention and should not be taken as an acknowledgement or any form of suggestion that this information forms the prior art already known to a person skilled in the art.

### SUMMARY

According to an aspect of the disclosure, a method of generating a facial avatar of a subject comprises capturing, by a Head Mounting Display (HMD) device through one or more image capturing devices associated with the HMD device, a plurality of facial images of a subject wearing the HMD device in a plurality of predefined perspectives; generating, by the HMD device based on perspective encoding of the plurality of facial images, perspective embedding vectors indicating a facial expression of the subject corresponding to each of the plurality of predefined perspectives; generating, by the HMD device from a pre-fed neutral facial image of the subject, neutral embedding feature vectors indicating an identity of the subject, the neutral facial image corresponding to an image in which a facial expression is not detected; generating, by the HMD device using an AI/ML based expression transfer model, a frontal facial image of the subject capturing the identity and the facial expressions of the subject based on a correlation of the perspective embedding vectors with the neutral embedding vectors; and performing, by the HMD device, Three-Dimensional (3D) morphing on the generated frontal facial image of the subject for generating the facial avatar of the subject.

According to an aspect of the disclosure, the method further comprises: generating, by the HMD device, a latent vector indicating a style of the subject by performing affine transformation on the neutral facial image of the subject; and generating, by the HMD device, the frontal facial image of the subject capturing the identity, facial expressions, and style of the subject based on a correlation of the latent vector with the perspective embedding vectors and the neutral embedding vectors.

According to an aspect of the disclosure, the capturing the plurality of facial images comprises capturing at least a part of a face of the subject in each of the plurality of facial images in the plurality of predefined perspectives.

According to an aspect of the disclosure, the plurality of predefined perspectives comprises a left eye perspective, a left face perspective, a right eye perspective, and a right face perspective.

According to an aspect of the disclosure, the one or more image capturing devices are synchronized and aligned to capture the plurality of facial images in the plurality of predefined perspectives.

According to an aspect of the disclosure, the perspective embedding vectors corresponding to each of the plurality of predefined perspectives are generated using a first deep neural network model based on a contrastive loss determination that determines a similarity score between two different vectors, wherein the first deep neural network model creates a plurality of expression clusters by grouping the perspective embedding vectors that indicate similar expressions of the subject.

According to an aspect of the disclosure, the generating the frontal facial image of the subject using the AI/ML based expression transfer model comprises: generating a first frontal facial image of the subject based on a correlation of first perspective embedding vectors from the perspective embedding vectors with the neutral embedding vectors, wherein a resolution of the generated first frontal facial image is a first resolution resulting in a first total loss higher than a predefined threshold loss; generating a second frontal facial image of the subject using at least a part of the generated first frontal facial image, and correlation of second perspective embedding vectors from the embedding vectors with the neutral embedding vectors, wherein a resolution of the generated second frontal facial image is a second resolution higher than the first resolution, resulting in a second total loss higher than the predefined threshold loss and lower than the first total loss; generating one or more subsequent frontal facial images of the subject using at least a part of the first frontal facial image or the second frontal facial image until a final total loss is lower than the predefined threshold loss, wherein each of the one or more subsequent frontal facial images is successively higher in resolution than a corresponding preceding frontal facial image; and determining a final frontal facial image from the one or more subsequent frontal facial images resulting in the final total loss lower than the predefined threshold loss as the frontal facial image of the subject.

According to an aspect of the disclosure, a method of generating an animated facial avatar of a subject comprises capturing, by a Head Mounting Display (HMD) device through one or more image capturing devices associated with the HMD device, a plurality of facial images of a subject wearing the HMD device, in a plurality of predefined perspectives; generating, by the HMD device based on perspective encoding of the plurality of facial images, perspective embedding vectors indicating facial expression of the subject corresponding to each of the plurality of predefined perspectives; generating, by the HMD device based on the perspective embedding vectors and an animated avatar selected by the subject, one or more Action Unit (AU) values and uncertainty values associated with each of the one or more AU values; predicting, by the HMD device using an AU prediction model, AU regressed data based on the plurality of facial images of the subject captured in a plurality of predefined perspectives; determining, by the HMD device based on the predicted AU regressed data and the uncertainty values corresponding to each of the one or more AU values, expression coefficients indicating an expression to be applied on the animated avatar selected by the subject; and generating, by the HMD device, the animated facial avatar comprising one or more expressions by applying the expression corresponding to the expression coefficients on the animated avatar selected by the subject.

According to an aspect of the disclosure, the determining the expression coefficients comprises: predicting, by the HMD device, one or more new AU values by fusing the AU regressed data with the uncertainty values, wherein the one or more new AU values have an accuracy higher than an accuracy of the one or more AU values; and determining, by the HMD device, based on the one or more new AU values using a blendshape co-efficient conversion model, the expression coefficients indicating expressions to be applied on the animated avatar selected by the subject.

According to an aspect of the disclosure, the method further comprises: switching, by the HMD device based on a user input, between a first mode and a second mode of generating avatars based on a user input, wherein the first mode corresponds to generating a non-animated facial avatar of the subject and the second mode corresponds to generating the animated facial avatar of the subject.

According to an aspect of the disclosure, a Head Mounting Display (HMD) device for generating a realistic facial avatar of a subject, the HMD device comprising: a processor; a memory, communicatively coupled to the processor, wherein the memory stores instructions, which, on execution, cause the processor to: capture, through one or more image capturing devices associated with the HMD device, a plurality of facial images of a subject wearing the HMD device in a plurality of predefined perspectives; generate, based on perspective encoding of the plurality of facial images, perspective embedding vectors indicating facial expression of the subject corresponding to each of the plurality of predefined perspectives; generate, from a pre-fed neutral facial image of the subject, neutral embedding feature vectors indicating identity of the subject, the neutral facial image corresponding to an image in which a facial expression is not detected; generate, using an AI/ML based expression transfer model, a frontal facial image of the subject capturing the identity and the facial expressions of the subject based on correlation of the perspective embedding vectors with the neutral embedding vectors; and perform by the HMD device, Three Dimensional (3D) morphing on the generated frontal facial image of the subject for generating the facial avatar of the subject.

According to an aspect of the disclosure, the processor is configured to: generate a latent vector indicating a style of the subject by performing affine transformation on the neutral facial image of the subject; and generate the frontal facial image of the subject capturing the identity, facial expressions and style of the subject based on a correlation of the latent vector with the perspective embedding vectors and the neutral embedding vectors.

According to an aspect of the disclosure, the capture of the plurality of facial images comprises capturing at least a part of a face of the subject in each of the plurality of facial images in the plurality of predefined perspectives.

According to an aspect of the disclosure, the plurality of predefined perspectives comprises a left eye perspective, a left face perspective, a right eye perspective, and a right face perspective.

According to an aspect of the disclosure, the processor synchronizes and aligns the one or more image capturing devices to capture the plurality of facial images in the plurality of predefined perspectives.

According to an aspect of the disclosure, the processor generates the perspective embedding vectors corresponding to each of the plurality of predefined using a first deep neural network model based on a contrastive loss determination that determines a similarity score between two different vectors, wherein the first deep neural network model creates a plurality of expression clusters by grouping the perspective embedding vectors that indicate similar expressions of the subject.

According to an aspect of the disclosure, to generate the frontal facial image of the subject using the AI/ML based expression transfer model, the processor is configured to: generate a first frontal facial image of the subject based on a correlation of first perspective embedding vectors from the perspective embedding vectors with the neutral embedding vectors, wherein a resolution of the generated first frontal facial image is a first resolution resulting in a first total loss higher than a predefined threshold loss; generate a second frontal facial image of the subject using at least a part of the generated first frontal facial image, and correlation of second perspective embedding vectors from the perspective embedding vectors with the neutral embedding vectors, wherein a resolution of the generated second frontal facial image is a second resolution higher than the first resolution, resulting in a second total loss higher than the predefined threshold loss and lower than the first total loss; generate one or more subsequent frontal facial images of the subject using at least a part of the first frontal facial image or the second frontal facial image until a final total loss is lower than the predefined threshold loss, wherein each of the one or more subsequent frontal facial images is successively higher in resolution than a corresponding preceding frontal facial image; and determining a final frontal facial image resulting in the final total loss lower than the predefined threshold loss as the frontal facial image of the subject.

According to an aspect of the disclosure, a Head Mounting Display (HMD) device for generating an animated facial avatar of a subject, the HMD device comprising: a processor; a memory, communicatively coupled to the processor, wherein the memory stores instructions, which, on execution, cause the processor to: capture, through one or more image capturing devices associated with the HMD device, a plurality of facial images of a subject wearing the HMD device in a plurality of predefined perspectives; generate, based on perspective encoding of the plurality of facial images, perspective embedding vectors indicating facial expression of the subject corresponding to each of the plurality of predefined perspectives; generate, based on the perspective embedding vectors and an animated avatar selected by the subject, one or more Action Unit (AU) values and uncertainty values associated with each of the one or more AU values; predict, using an AU prediction model, AU regressed data based on the plurality of facial images of the subject captured in a plurality of predefined perspectives; determine, based on the predicted AU regressed data and the uncertainty values corresponding to each of the one or more AU values, expression coefficients indicating an expression to be applied on the animated avatar selected by the subject; and generate the animated facial avatar comprising one or more expressions by applying the expression corresponding to the expression coefficients on the animated avatar selected by the subject.

According to an aspect of the disclosure, to determine the expression coefficients, the processor is configured to: predict one or more new AU values by fusing the AU regressed data with the uncertainty values, wherein the one or more new AU values have an accuracy higher than an accuracy of the one or more AU values; and determine, based on the one or more new AU values, using a blendshape co-efficient conversion model, the expression coefficients indicating expressions to be applied on the animated avatar selected by the subject.

According to an aspect of the disclosure, the processor is further configured to switch, based on a user input, between a first mode and a second mode of generating avatars based on a user input, wherein the first mode corresponds to generating a non-animated facial avatar of the subject, and the second mode corresponds to generating the animated facial avatar.

### BRIEF DESCRIPTION OF DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1A shows an exemplary architecture for generating a realistic facial avatar of a subject in a Head Mounting Display (HMD) device, in accordance with some embodiments of the present disclosure;

FIG. 1B illustrates an exemplary scenario depicting cameras in HMD for generating a realistic facial avatar of a subject, in accordance with some embodiments of the present disclosure;

FIGS. 1C-1E illustrates exemplary embodiments illustrating various features in detail of generating a realistic facial avatar of a subject, in accordance with some embodiments related to the present disclosure;

FIG. 2A depicts a detailed block diagram of HMD generating a realistic facial avatar of a subject, in accordance with some embodiments related to the present disclosure;

FIG. 2B depicts a detailed block diagram of HMD generating a cartoon facial avatar of a subject, in accordance with some embodiments related to the present disclosure;

FIG. 2C illustrates an exemplary 3D mesh, a texture and texture wrapped around the 3D mesh in accordance with some embodiments related to the present disclosure;

FIG. 2D shows an exemplary data collection and annotation flow in accordance with some embodiments of the present disclosure;

FIG. 3A depicts a flowchart illustrating a method of generating a realistic facial avatar of a subject, in accordance with some embodiments of the present disclosure;

FIG. 3B depicts a flowchart illustrating a method of generating an animated facial avatar of a subject, in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

In recent years, the conventional methods are limited to either creating a Three-Dimensional (3D) face avatar or an animated avatar of the user. There is a need for a hybrid solution that can provide both generation of 3D realistic facial avatar and an animated avatar. Further, there is a need to address the above-mentioned technical problems. In order to solve the aforementioned problem, the present disclosure discloses a method and apparatus for generating a realistic facial avatar and an animated facial avatar of a subject. In the present disclosure, HMD device generates the realistic facial avatar or an animated facial avatar based on images of different perspectives. In one or more examples, these perspectives include, but are not limited to, left eye perspective, left face perspective, right eye perspective, and right face perspective captured through one or more image capturing devices positioned in the HMD device in a manner that capture the different perspectives effectively. As a result, these features ensure an enhanced way of capturing the expressions for the realistic facial images or animated facial images, and helps in achieving accurate representation of the subject's face, irrespective of the placement of the HMD, the size of the user's head, or any other unique facial characteristics of the user. Further, the present disclosure provides a hybrid approach that enables the user to generate both a realistic facial avatar and an animated facial avatar. Therefore, the present disclosure provides the user flexibility to switch between the generation of realistic facial avatar or an animated facial avatar. Furthermore, such a hybrid approach enables the user the choice to preserve their identity when required using an animated avatar, or use their realistic avatar in other scenarios.

The present disclosure advantageously provides a lightweight architecture that enables switching seamlessly between the realistic facial avatar and animated facial avatar of user's choice due to the ability of the light weight architecture designed to execute and seamlessly to support both the modes of generation. Further, the AI/ML models used in the present disclosure are trained based on geometry of facial features, texture and IR images of users of various ethnicities and skin colors, thereby enabling effective face tracking, and generation of accurate realistic facial avatar or animated facial avatar for any ethnicity or skin color of the subject. Furthermore, in the present disclosure, the AI/ML models are trained on IR images captured via IR cameras. Therefore, the present disclosure fills the domain gap between HMD perspective images and the training data which makes the face tracking effective despite different style and distortions of the IR images compared to normal RGB or grayscale images.

Therefore, the present disclosure advantageously provides an improvised method and system for generating a realistic and animated facial avatar of a subject that help depict true-to-life facial expressions in the realistic/animated facial avatar generated using the HMD device and enhance interactions in virtual environments. For instance, the method disclosed in the present disclosure may be utilized in gaming applications to enhance gaming experiences by enabling transfer of facial expressions onto custom made special characters. In another example, the present disclosure may be utilized in presentations, online coaching, online video conferences, customer service management, workplace etiquette, training and the like, and enables users to track and improve their emotional preparedness.

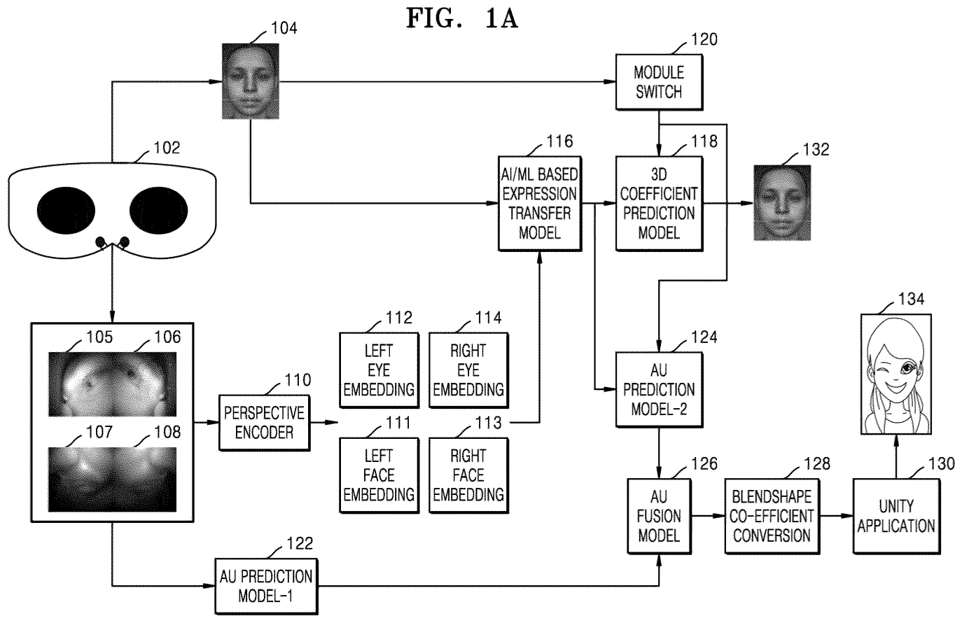

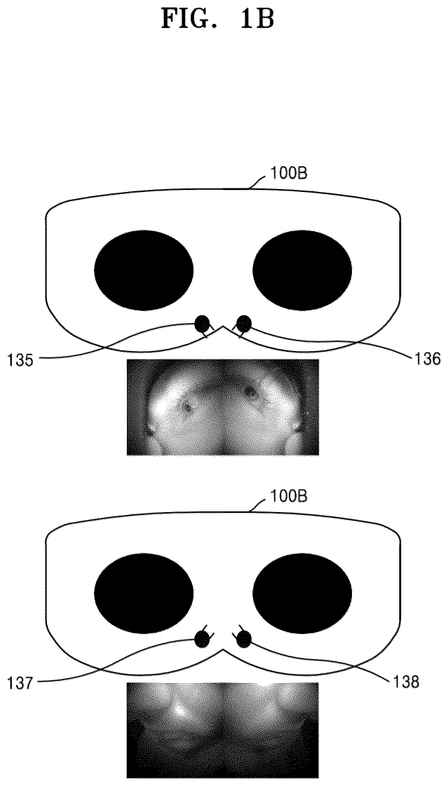

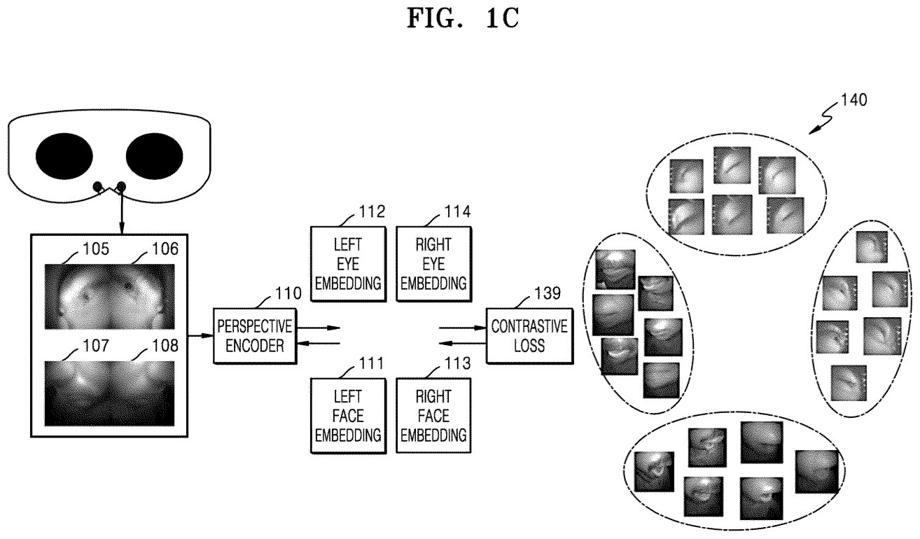

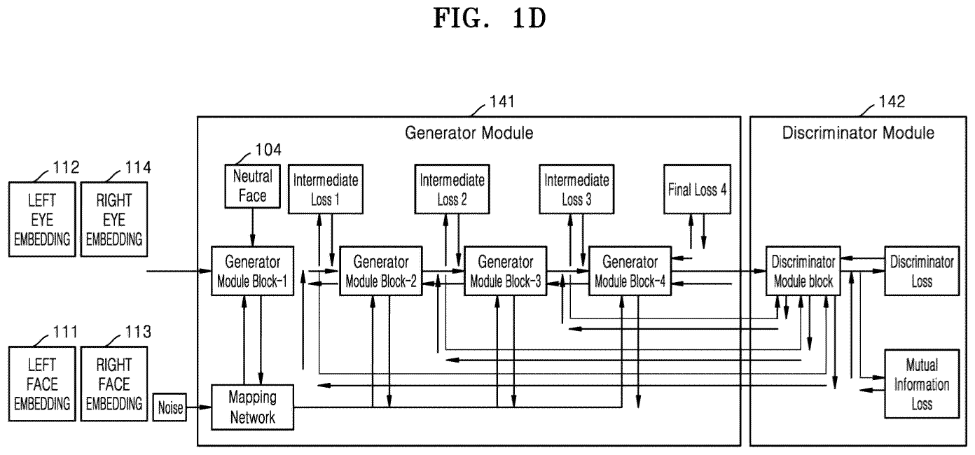

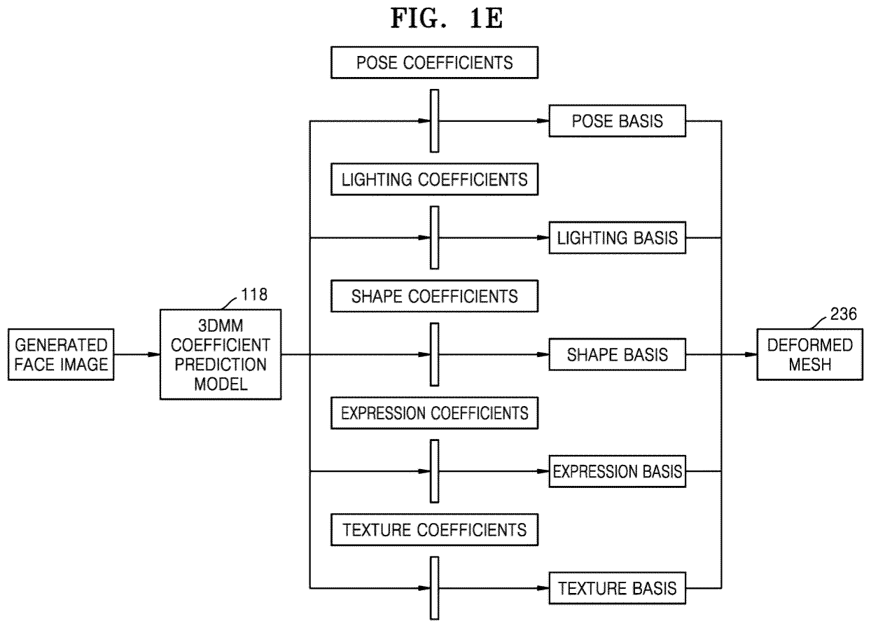

FIG. 1A shows an architecture diagram for generating a realistic facial avatar 132 of a subject, in accordance with some embodiments of the present disclosure. In some embodiments, the realistic facial avatar may be a virtual facial image that has an appearance similar to a real face of the subject, or in other words, an appearance that resembles the real face of the subject. FIG. 1B illustrates a scenario depicting cameras in Head Mounting Display (HMD) device for generating a realistic facial avatar 132 of a subject, in accordance with some embodiments of the present disclosure. FIGS. 1C-1E illustrate exemplary embodiments illustrating various features in detail of generating a realistic facial avatar 132 of a subject, in accordance with some embodiments related to the present disclosure.

The architecture includes an HMD device 102 that may generate the realistic facial avatar 132 of a subject. The subject may be an image of a user using the HMD device 102. As shown in the FIG. 1B, the HMD device 102 comprises one or more image capturing devices 135-138. These image capturing devices may capture a plurality of facial images of a subject in a plurality of predefined perspectives 105-108 wearing the HMD device 102. The plurality of predefined perspectives 105-108 are the perspectives captured that is a part of a user. In each of the plurality of facial images in the plurality of predefined perspectives, the plurality of predefined perspectives 105-108 may include, but not limited to, a left eye perspective 105, a left face perspective 107, a right eye perspective 106, and a right face perspective 108. The one or more image capturing devices 135-138 may be synchronized and may be aligned to capture the plurality of facial images in the plurality of predefined perspectives 105-108. In one or more examples, the predefined perspectives may be defined based on a position of a respective image capturing device on the HMD device 102. For example, FIG. 1B illustrates a view of the HMD device 102 from the perspective of a user. An image capturing device placed near a left of a user (e.g., 137) may correspond to a left eye perspective. An image capturing device placed near a right of the user (e.g., 138) may correspond to a right eye perspective. An image capturing device placed below the left eye of the user (e.g., 135) may correspond to a left face perspective. An image capturing device placed below the right of the user (e.g., 136) may correspond to a right face perspective.

Upon capturing the plurality of facial images, the HMD device 102 may generate perspective embedding vectors. In one or more examples, the perspective embedding vectors may indicate a facial expression of the subject corresponding to each of the plurality of predefined perspectives, based on perspective encoding of the plurality of facial images. The perspective embedding vectors may include, but not limited to, a left face embedding vector 111, a left eye embedding vector 112, a right face embedding vector 113, and a right eye embedding vector 114. Further, the HMD device 102 may generate neutral embedding feature vectors. The neutral embedding feature vectors may indicate an identity of the subject from a pre-fed neutral facial image of the subject. The pre-fed neutral face image 104 of the subject may be captured using an electronics device associated with the subject. In one or more examples, a neutral face image may be an image of a subject's face in which no facial expression is detected. In one or more examples, the perspective embedding vectors corresponding to each of the plurality of predefined perspectives are generated using a first deep neural network model based on contrastive loss determination 139.

In one or more examples, the first deep neural network model may be a deep CNN-based model. In some embodiments, the contrastive loss may be used to create embedding clusters based on expressions. Therefore, the first deep neural network model learns similar representations for similar expressions from different subjects and dissimilar representations for different expressions of the same subject or different subjects. The first deep neural network model creates a plurality of expression clusters by grouping the perspective embedding vectors that indicate similar expressions of the subject. For example, if one expression cluster indicates a smile with value 1, then similarly the expression cluster indicating a smile with value 1 are combined in a cluster 1 as shown in FIG. 1C. The first deep neural network may be referred as perspective encoder 110 in the Figures. As shown in FIG. 1C, based on the contrastive loss determination 139, the first deep neural network model may learn similar representations for similar expressions from different subjects and dissimilar representations for different expressions of the same subject or different subjects. Irrespective of the identity of the subject, the first deep neural network model has the ability to capture the expressions of the subjects based on the contrastive loss determination 139. In one or more examples, a contrastive loss determination provides a score indicating a similarity between to vectors.

Upon generating the embedding vectors, the HMD device 102 may generate a frontal facial image of the subject capturing the identity and the facial expressions of the subject based on correlation of the perspective embedding vectors with the neutral embedding vectors using an AI/ML based expression transfer model 116. As shown in FIG. 1D, the AI/ML based expression transfer model 116 includes a generator module 141 and a discriminator module 142 utilized to generate the frontal facial image. The discriminator module 142 may determine if the generated image from the image block is a real image or a fake image. In one or more examples, the AI/ML based expression transfer model 116 with the help of the generator module 141, may generate a first frontal face image of the subject based on a correlation of the perspective embedding vectors with the neutral embedding vectors. The resolution of the first frontal facial image may be a first resolution. For example, consider the first resolution to be 32*32. The AI/ML based expression transfer model 116 may determine an initial discriminator loss based on comparison of the generated initial frontal facial image and the neutral image of the subject. In one or more examples, a face reconstruction loss may act as auxiliary loss to maintain identity plus expression consistency with the user. In one or more examples, a face identity recognition loss may be utilized to maintain identity of the face. The face identity recognition loss may be propagated in a feature space. In one or more examples, a face expression recognition loss may help in generating expression accurately. The face expression recognition loss may be propagated in the feature space. Further, a standard generator loss may be considered to maintain high fidelity in generated facial images. Similarly, the facial images may be generated up to a resolution of 512*512. Based on the aforementioned loss functions, the AI/ML based expression transfer model 116 may be trained to advantageously generate the frontal facial image with an accurate resemblance of the user.

Further, in some embodiments, as disclosed above, the steps of generating subsequent frontal facial images may be iterated one or more times. For instance, a first frontal facial image of the subject generated by the AI/ML based expression transfer model 116 based on the correlation of first perspective embedding vectors with the neutral embedding vectors may have a resolution that is a first resolution resulting in a first total loss higher than a predefined threshold loss. Therefore, the AI/ML based expression transfer model 116 may generate a second frontal facial image of the subject using at least a part of the generated first frontal facial image, and correlation of second perspective embedding vectors with the neutral embedding vectors. In one or more examples, the generated second frontal facial image may have a resolution that is a second resolution higher than the first resolution, resulting in a second total loss higher than the predefined threshold loss and lower than the first total loss. Similarly, the AI/ML based expression transfer model 116 may generate one or more subsequent frontal facial images of the subject using at least a part of one or more previously generated frontal facial images until a final total loss is lower than the predefined threshold loss. In one or more examples, each of the one or more subsequent frontal facial images is successively higher in resolution than its corresponding preceding frontal facial image. Finally, the AI/ML based expression transfer model 116 may infer the subsequent frontal facial image (e.g., determining a final frontal facial image) resulting in the final total loss lower than the predefined threshold loss as the frontal facial image of the subject. The discriminator loss helps in improving quality of generated images. Further, the discriminator loss function may also consider a mutual information loss which is a loss constructed on maintaining maximum information between the feature projection on a generated image and a feature projection on a ground truth image.

In some embodiments, to further customize the 3D avatar as per the user, the HMD device 102 may generate a latent vector indicating a style of the subject by performing affine transformation on the neutral facial image of the user. Further, the HMD device 102 may generate the frontal facial image of the subject capturing the identity, facial expressions and style of the subject based on correlation of the latent vector with the perspective embedding vectors and the neutral embedding vectors.

In this context, the affine transformation may be performed by aligning the neutral facial image to a predefined reference coordinate system based on facial landmarks detected from the image. The transformation matrix may be computed by establishing a correspondence between specific facial landmarks—such as the outer corners of the eyes and the corners of the mouth—and standard positions in the reference space. For example, the detected coordinates of the eye corners and mouth corners in the neutral facial image may be used to calculate an affine matrix that adjusts rotation, scale, and position to align the face into a canonical frontal pose. This alignment allows consistent style extraction across subjects and conditions, contributing to a more accurate and personalized 3D avatar.

Upon generation of the frontal facial image, the HMD device 102 may perform Three-Dimensional (3D) morphing on the generated frontal facial image of the subject for generating realistic avatar of the subject as shown in FIG. 1E. For example, the 3D morphing may provide a transition from a source image to a target image such that movements of a resulting avatar appear realistic. The generated frontal facial image may be passed through a pre-trained 3DMM coefficient prediction model 118. The 3DMM coefficient prediction model 118 may extract pose coefficients, lighting coefficients, shape coefficients, expression coefficients and texture coefficients from 3DMM coefficients generated based on the frontal facial image. The aforementioned coefficients may be multiplied with pose basis, lighting basis, shape basis, expression basis and texture basis to obtain a deformed mesh 236 with expression. In some embodiments, using a Convolutional Neural Network (CNN) based texture generation model, a texture may be generated in a UV space and may be wrapped around the deformed mesh 236 to generate the realistic avatar of the subject.

In one or more embodiments, the HMD device 102 may also generate an animated facial avatar 134 of the subject. In some embodiments, the animated facial avatar may be an animated facial image that has an appearance of an animated character selected by a user and shows expressions of the subject wearing the HMD device 102. As shown in the FIG. 1A, for generating the animated facial avatar 134, the HMD device 102 may generate one or more Action Unit (AU) values based on the perspective embedding vectors and an animated avatar selected by the subject. In some embodiments, AU values may indicate movement of a facial muscle or muscle groups of the subject that configure the expression of an emotion. In one or more examples, this configuration may be based on Paul Ekman's Facial Action Coding System (FACS). In some embodiments, the HMD device 102 may use a classification model to generate the one or more AU values. The HMD device 102 may convert a plurality of AU into blend-shape coefficients on a unity application for generating the animated avatar 134 of the subject. The HMD device 102 may predict AU regressed data based on the plurality of facial images of the subject captured in a plurality of predefined perspectives, using an AU prediction model. In some embodiments, the HMD device 102 may determine expression coefficients indicating an expression to be applied on the animated avatar selected by the subject, based on the predicted AU regressed data and the uncertainty values corresponding to each of the one or more AU values. Thereafter, the HMD device 102 generates an expressive animated avatar by applying the expression corresponding to the expression coefficients on the animated avatar selected by the subject. For example, the expressive animated avatar may show facial expressions such as smiling, laughing, sadness, anger, surprise, etc.

The switch from generation of the realistic facial avatar 132 to the animated facial avatar 134 may be performed using a module switch 120. In one or more examples, the module switch may be a physical switch provided on the HMD device 102. In one or more examples, the switching from generating the realistic facial avatar 132 to the animated facial avatar 143, and vice versa, may be performed via a voice command.

In some embodiments, for training the perspective encoder, a CNN based encoder model is trained on four perspective input images based on a plurality of perspective images. In one or more examples, the Perspective Encoder 110 generates embeddings for the four perspectives which are thereafter used by subsequent models. The Perspective Encoder 110 may be a network for all four perspectives and a back propagation is driven by the contrastive loss determination. A neutral embedding of the neutral image of the user, and perspective embedding vectors may be utilized as inputs along with noise to generate a face identical to the neutral face with expression transferred from perspective embeddings vectors. A discriminator module identifies the fake images from the neutral images. The Generator Loss, Face Expression Recognition Loss, Face Identity Recognition Loss, Mutual Information loss may be utilized to learn about the expression and identity of the user in an accurate manner for generation of the realistic facial avatar.

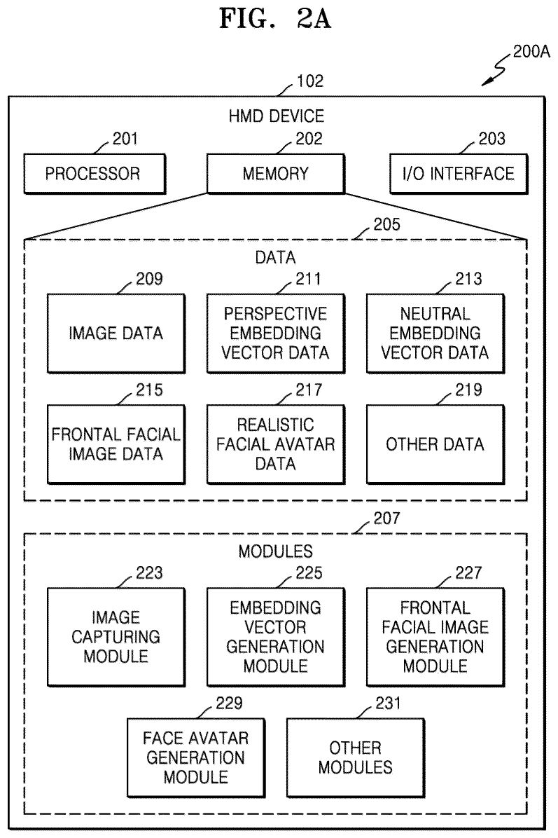

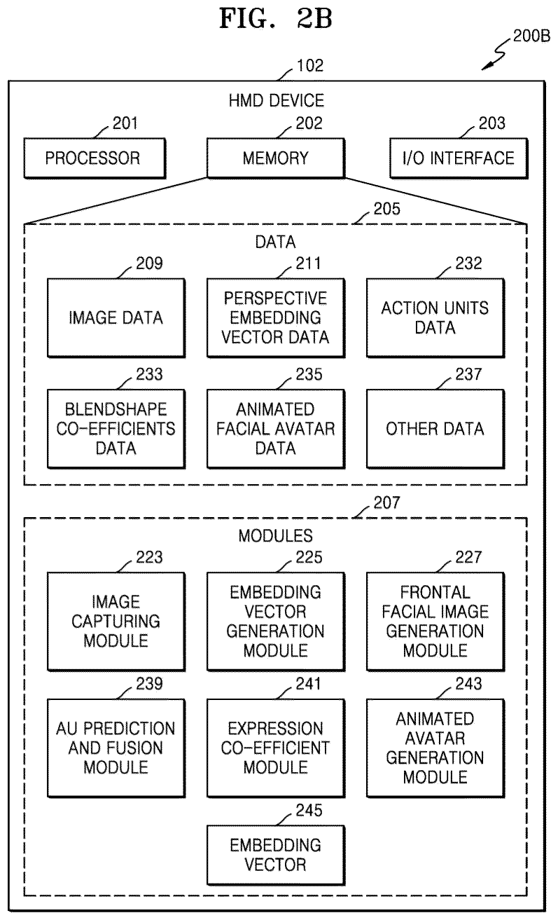

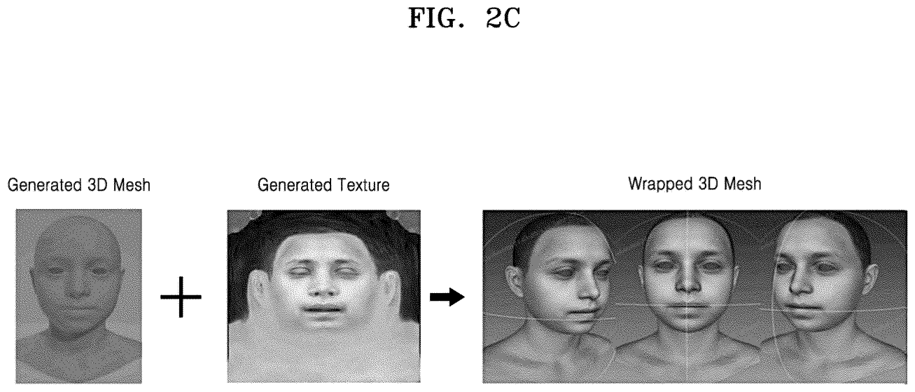

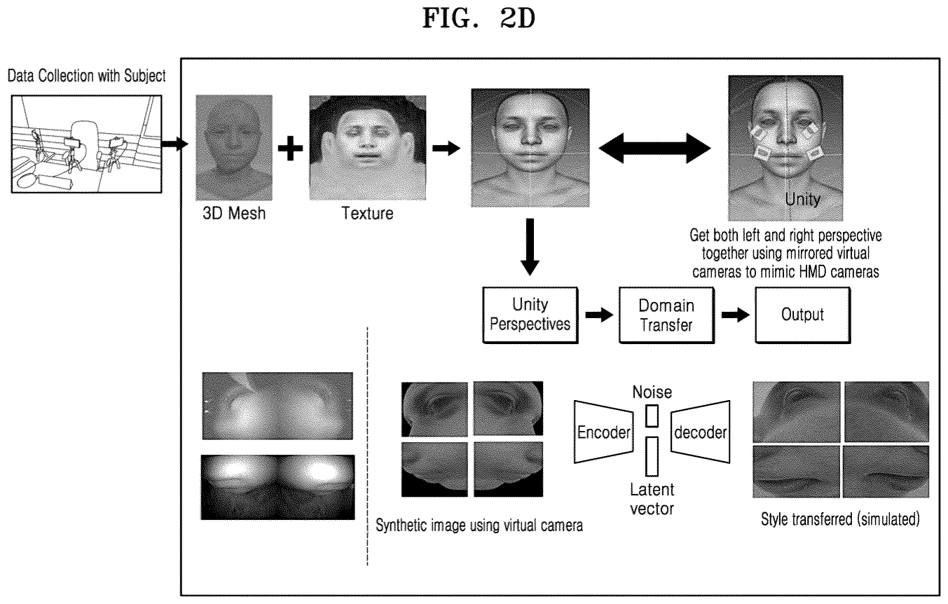

FIG. 2A depicts a detailed block diagram of HMD device 102 generating a realistic facial avatar 132 of a subject, in accordance with some embodiments related to the present disclosure. FIG. 2B depicts a detailed block diagram of HMD device 102 generating an animated facial avatar of a subject, in accordance with some embodiments related to the present disclosure.

In some embodiments, the HMD device 102 may include a processor 201, an I/O interface 203 and a memory 202. The I/O interface 203 may be configured for receiving and transmitting an input signal or/and an output signal related to one or more operations of the HMD device 102. The memory 202 may be communicatively coupled to the processor 201 and one or more modules 207. The processor 201 may be configured to perform one or more functions of the HMD device 102 using data 205 and the one or more modules 207.

In one or more embodiments, the data 205 stored in the memory 202 may include without limitation image data 209, perspective embedding vector data 211, neutral embedding vector data 213, frontal facial image data 215, realistic facial avatar data 217 and other data 219. In some implementations, the data 205 may be stored within the memory 202 in the form of various data structures. Additionally, the data 205 may be organized using data models. The other data 219 may include various temporary data and files generated by the different components of the HMD device 102 while generating the realistic facial avatar of the subject.

The image data 209 may include a plurality of facial images of a subject wearing the HMD device 102 in a plurality of predefined perspectives. In some embodiments, the plurality of the facial images may be captured using one or more image capturing devices associated with the HMD device 102. Capturing the plurality of facial images by the one or more image capturing devices may include capturing a part of a face of a user in each of the plurality of images in the plurality of predefined perspectives. The plurality of predefined perspectives may include, but not limited to, a left eye perspective 105, a left face perspective 107, a right eye perspective 106, and a right face perspective 108. In some embodiments, the one or more image capturing devices are synchronized and aligned to capture the plurality of facial images in the plurality of predefined perspectives. In one or more examples, the plurality of facial images may be captured sequentially at predetermining timing intervals. In one or more examples, the plurality of facial images may be captured simultaneously.

In one or more examples, the perspective embedding vector data 211 includes perspective embedding vectors indicating facial expressions of the subject. In some embodiments, the perspective embedding vectors may correspond to each of the plurality of predefined perspectives.

In one or more examples, the neutral embedding vector data 213 includes neutral embedding feature vectors indicating identity of the subject.

In one or more examples, the frontal facial image data 215 may include frontal facial images of the subject capturing the identity and the facial expressions of the subject based on correlation of the perspective embedding vectors with the neutral embedding vectors.

In one or more examples, the realistic facial avatar data 217 may include realistic facial avatars of the subject generated based on Three-Dimensional (3D) morphing of the generated frontal facial image of the subject.

In some embodiments, data 205 may be processed by the one or more modules 207 of the HMD device 102. In one or more examples, the one or more modules 207 may include, but not limited to, an image capturing module 223, embedding vector generation module 225, frontal facial image generation module 227, facial avatar generation module 229 and other modules 231. In one or more embodiments, the other modules 231 may be used to perform various miscellaneous functionalities of the HMD device 102 while generating the realistic facial avatar of the subject. It will be appreciated that such one or more modules 207 may be represented as a single module or a combination of different modules.

In one or more embodiments, the image capturing module 223 may be configured to capture a plurality of facial images of a subject wearing the HMD device 102, in the plurality of predefined perspectives through the one or more image capturing devices associated with the HMD device 102.

In the exemplary embodiment, the embedding vector generation module 225 may be configured to generate perspective embedding vectors based on perspective encoding of the plurality of facial images. In some embodiments, the embedding vector generation module 225 may generate the perspective embedding vectors corresponding to each of the plurality of predefined perspectives using a first deep neural network model based on contrastive loss determination. In some embodiments, the first deep neural network model creates a plurality of expression clusters by grouping the perspective embedding vectors that indicate similar expressions of the subject. In some embodiments, the embedding vector generation module 225 may be trained on plurality of facial images belonging to the predefined perspectives (e.g., perspective images). Each of the perspective images is projected to an embedding through the first deep neural network model and a back propagation is driven through contrastive loss. In some embodiments, the embedding vector generation module 225 may be trained in two modes comprising a first mode and a second mode. In one or more embodiments, the first mode may include disentangling identity of the subject from the expression and the second mode may include applying a contrastive clustering on the perspective embedding vectors to bring similar expression embeddings together while pushing different expression embeddings apart. In some embodiments, the embedding vector generation module 225 may be further configured to generate neutral embedding feature vectors indicating identity of the subject from a pre-fed neutral facial image of the subject.

In some embodiments, the frontal facial image generation module 227 may be configured to generate the frontal facial image of the subject capturing the identity and the facial expressions of the subject based on correlation of the perspective embedding vectors with the neutral embedding vectors using an AI/ML based expression transfer model 116. In some embodiments, frontal facial image generation of the subject may be an iterative process. To generate the frontal facial image, the frontal facial image generation module 227 may generate a first frontal facial image of the subject generated by the AI/ML based expression transfer model 116 based on the correlation of the first perspective embedding vectors with the neutral embedding vectors. The resolution of the generated first frontal facial image may be a first resolution resulting in a first total loss higher than a predefined threshold loss. Therefore, the frontal facial image generation module 227 may use the AI/ML based expression transfer model 116 to further generate a second frontal facial image of the subject using at least a part of the generated first frontal facial image, and correlation of second perspective embedding vectors with the neutral embedding vectors. In some embodiments, the resolution of the generated second frontal facial image may be a second resolution higher than the first resolution, resulting in a second total loss higher than the predefined threshold loss and lower than the first total loss. Therefore, the frontal facial image generation module 227 may use the AI/ML based expression transfer model 116 to continue with generating one or more subsequent frontal facial images of the subject using at least a part of one or more previously generated frontal facial images until a final total loss is lower than the predefined threshold loss. Each of the one or more subsequent frontal facial images may be successively higher in resolution than its corresponding preceding frontal facial image. Finally, the frontal facial image generation module 227 may infer the subsequent frontal facial image (e.g., determining a final frontal facial image) resulting in the final total loss lower than the predefined threshold loss as the frontal facial image of the subject.

For instance, the first frontal facial image may be of a first resolution 32×32 which may generate coarse expressions in the first frontal facial image. As shown in the FIG. 1D, generator module block-1 may generate the first frontal facial image of the first resolution 32×32 for which total loss is computed based on generator loss functions and discriminator loss functions. This loss may be indicated via intermediate loss-1 as shown in the FIG. 1D. Thereafter, the second frontal facial image may be of a first resolution 64×64 which may generate finer expressions compared to the coarse expressions that were previously generated in the first frontal facial image. As shown in the FIG. 1D, the generator module block-2 may generate the second frontal facial image of the second resolution 64×64 for which total loss is computed based on generator loss functions and discriminator loss functions. This loss may be indicated via intermediate loss-2 as shown in the FIG. 1D. Further, the subsequent frontal facial image (in this context, a third frontal facial image) may be of a third resolution 128×128 which may generate more finer expressions compared to the finer expressions that were previously generated in the second frontal facial image. As shown in the FIG. 1D, the generator module block-3 may generate the third frontal facial image of the third resolution 128×128 for which total loss is computed based on generator loss functions and discriminator loss functions. This loss may be indicated via intermediate loss-3 as shown in the FIG. 1D. Furthermore, the subsequent frontal facial image (in this context, a fourth frontal facial image) may be of a fourth resolution 256×256 which may generate finest expressions compared to the finer expressions that were previously generated in the third frontal facial image. As shown in the FIG. 1D, the generator module block-4 may generate the fourth frontal facial image of the fourth resolution 256×256 for which total loss is computed based on generator loss functions and discriminator loss functions. This loss may be indicated via final loss-4 as shown in the FIG. 1D. In some embodiments, the loss generated after four iterations may be considered as final loss in this example, as the loss is determined to be less than the predefined threshold loss. In one or more examples, the frontal facial image generation process may be performed a predetermined number of times. In one or more examples, the frontal facial image generation process may be performed until a predetermined condition is satisfied. For example, the frontal facial image generation process may be performed until a generated image has a resolution that is equal to or greater than a resolution threshold.

Therefore, the frontal facial image generation module 227 may proceed to iteratively generate a subsequent frontal facial image of a higher resolution compared to a previous frontal facial image of the subject, and determine a total loss based on each subsequent frontal facial image which is generated until the total loss is determined to be less than the predefined threshold loss. In some embodiments, the total loss less than the predefined threshold loss indicates enhancement in accuracy of predictions of the AI/ML based expression transfer model 116. In some embodiments, the frontal facial image generation module 227 computes loss based on generator loss functions and discriminator loss functions. In one or more examples, the generator loss functions may include a generator loss, a face identity recognition loss, face expression recognition loss, and reconstruction loss. In one or more examples, the discriminator loss functions may include a discriminator loss and a mutual information loss. The generator loss functions and the discriminator loss functions help in improving quality of generated images.

In one or more embodiments, to further customize the 3D avatar as per an appearance of the user or per a predetermined requirement, the frontal facial image generation module 227 may be configured to generate a latent vector indicating style of the subject by performing affine transformation on the neutral facial image of a user. In such instances, the frontal facial image generation module 227 may generate the frontal facial image of the subject by capturing the identity, facial expressions and even style of the subject based on correlation of the latent vector with the perspective embedding vectors and the neutral embedding vectors.

In some embodiments, the facial avatar generation module 229 may be configured to perform 3D morphing on the generated frontal facial image of the subject for generating realistic avatar of the subject. 3D morphing may be generated using a pre-trained 3D morphing model such as, for example, a pre-trained 3DMM coefficient prediction model 118. In some embodiments, the 3D morphing model of a ResNet architecture may construct a 3D mesh of the subject based on the generated frontal facial image of the subject which is 2D in nature. In some embodiments, the constructed 3D mesh of the subject has an approximate shape and expression of the subject. To generate the 3D mesh, the 3DMM co-efficient prediction model may initially extract shape and expression coefficients that provide a shape and expression basis. Further, the 3DMM co-efficient prediction model may extract pose and lighting coefficients from the 3DMM coefficients that provide a light and head pose basis. Also, the 3DMM co-efficient prediction model may extract texture coefficients that provides a texture basis. Thereafter, the shape and expression coefficients may be multiplied with shape and expression basis vectors to get vertex and face positions of the 3D mesh. In some embodiments, the 3D morphable model may also incorporate lighting and an estimated head pose basis to the 3D mesh. Further, the facial avatar generation module 229 may use a CNN based texture generation model to generate texture in UV space using the extracted texture coefficients and generated 2D frontal facial image which is wrapped around the 3D mesh of the subject to generate the realistic facial avatar of the subject. FIG. 2C illustrates a generated 3D mesh, a generated texture, and the texture wrapped around the 3D mesh. In some embodiments, the 3D mesh with texture may also be referred as a Digital Persona of the subject.

FIG. 2B depicts a detailed block diagram of HMD device 102 generating an animated facial avatar 132 of a subject, in accordance with some embodiments related to the present disclosure.

In some embodiments, the HMD device 102 may include a processor 201, an I/O interface 203 and a memory 202. The I/O interface 203 may be configured for receiving and transmitting an input signal or/and an output signal related to one or more operations of the HMD device 102. The memory 202 may be communicatively coupled to the processor 201 and one or more modules 207. The processor 201 may be configured to perform one or more functions of the HMD device 102 using data 205 and the one or more modules 207.

In one or more embodiments, the data 205 stored in the memory 202 may include without limitation image data 209, perspective embedding vector data 211, action units data 232, blend shape co-efficient data 233, animated facial avatar data 235 and other data 237. In some implementations, the data 205 may be stored within the memory 202 in the form of various data structures. Additionally, the data 205 may be organized using data models. The other data 237 may include various temporary data and files generated by the different components of the HMD device 102 while performing the method of generating the animated facial avatar of the subject.

In some embodiments, the image data 209 may include a plurality of facial images of a subject wearing the HMD device 102 in a plurality of predefined perspectives. In some embodiments, the plurality of the facial images may be captured using one or more image capturing devices associated with the HMD device 102. Capturing the plurality of facial images by the one or more image capturing devices may include capturing a part of a face of a user in each of the plurality of images in the plurality of predefined perspectives. The plurality of predefined perspectives may include, but not limited to, a left eye perspective 105, a left face perspective 107, a right eye perspective 106, and a right face perspective 108. In some embodiments, the one or more image capturing devices are synchronized and aligned to capture the plurality of facial images in the plurality of predefined perspectives.

In some embodiments, the perspective embedding vector data 211 includes perspective embedding vectors indicating facial expressions of the subject. In some embodiments, the perspective embedding vectors may correspond to each of the plurality of predefined perspectives.

In some embodiments, the Action Units Data 232 may include one or more action unit values predicted using an AU prediction model and uncertainty values corresponding to each of the one or more action unit values predicted for generation of animated avatar 134. The AU values may indicate the movement of a facial muscle or muscle groups of the subject, that configure the expression of an emotion, based on Paul Ekman's Facial Action Coding System (FACS). In some embodiments, the uncertainty values may indicate how sure a model is while predicting one or more action unit values. In some embodiments, the uncertainty values may be used to fuse action unit regressed data to predict much accurate action unit values.

In some embodiments, the blend-shape coefficients data 233 may include expression coefficients indicating an expression to be applied on the animated avatar selected by the subject. The expression coefficients may also be referred as blendshape coefficients. In some embodiments, number of blendshape coefficient values and values of blendshape coefficient values may vary based on an animated avatar selected by the subject.

In some embodiments, the animated facial avatar data 235 may include animated facial avatars of the subject generated by applying expressions corresponding to the expression coefficients on the animated avatar selected by the subject.

In some embodiments, data 205 may be processed by the one or more modules 207 of the HMD device 102. In one or more examples, the modules 207 may include, without limiting to, an image capturing module 223, embedding vector generation module 225, front facial image generation module 227, Action Unit (AU) prediction and fusion module 239, expression coefficient module 241, animated avatar generation module 243 and other modules 245. In one or more embodiments, the other modules 245 may be used to perform various miscellaneous functionalities of the HMD device 102 for generating the animated facial avatar of the subject. As understood by one of ordinary skill in the art, the modules 207 may be represented as a single module or a combination of different modules.

In one or more embodiments, the image capturing module 223 may be configured to capture a plurality of facial images of a subject wearing the HMD device 102, in the plurality of predefined perspectives through the one or more image capturing devices associated with the HMD device 102.

In the exemplary embodiment, the embedding vector generation module 225 may be configured to generate perspective embedding vectors based on perspective encoding of the plurality of facial images. In some embodiments, the embedding vector generation module 225 may generate the perspective embedding vectors corresponding to each of the plurality of predefined perspectives using a first deep neural network model based on contrastive loss determination. In some embodiments, the first deep neural network model creates a plurality of expression clusters by grouping the perspective embedding vectors that indicate similar expressions of the subject. In some embodiments, the embedding vector generation module 225 may be trained on plurality of facial images belonging to the predefined perspectives (e.g., perspective images). Each of the perspective images is projected to an embedding through the first deep neural network model and a back propagation is driven through contrastive loss. In some embodiments, the embedding vector generation module 225 may be trained in two modes comprising a first mode and a second mode. In one or more embodiments, the first mode may include disentangling identity of the subject from the expression and the second mode may include applying a contrastive clustering on the perspective embedding vectors to bring similar expression embeddings together while pushing different expression embeddings apart. In some embodiments, the embedding vector generation module 225 may be further configured to generate neutral embedding feature vectors indicating identity of the subject from a pre-fed neutral facial image of the subject.

In some embodiments, the frontal facial image generation module 227 may be configured to generate the frontal facial image of the subject capturing the identity and the facial expressions of the subject based on correlation of the perspective embedding vectors with the neutral embedding vectors using an AI/ML based expression transfer model 116, through an iterative process explained in detail under the explanation in FIG. 2A. Content of the FIG. 2A where the iterative process for generating the frontal facial image of the subject is explained under FIG. 2A is referred here in entirety.

In some embodiments, the AU prediction and fusion module 239 may generate one or more AU values and uncertainty values associated with each of the one or more AU values based on the perspective embedding vectors and the animated avatar selected by the subject. The AU prediction and fusion module 239 may comprise a pre-trained AI/ML prediction model that regresses action units based on perspective embedding vectors corresponding to the plurality of perspectives. For each action unit, the pre-trained AI/ML prediction model predicts a corresponding uncertainty value that indicates how sure the pre-trained AI/ML prediction model is while predicting one or more action unit values. Further, AU prediction and fusion module 239 may regress the action units based on plurality of facial images of the subject using the pre-trained AI/ML prediction model. In some embodiments, the plurality of facial images of the subject may be the generated frontal facial image of the subject.

In some embodiments, the pre-trained AI/ML model may include an AU prediction model-1 122 and an AU prediction model-2 124. The AU prediction model-1 122 may use IR images of all four perspectives (e.g., two eye perspectives and two face perspectives as input). The two eye perspectives have a shared model for extracting eye projected embeddings. The two face perspectives have a shared model for extracting face projected embeddings. In some embodiments, the AU prediction model-1 122 may concatenate all the four extracted embeddings i.e., eye projected embeddings and face projected to form a final projection vector. The final projection vector is used to regress AU values and uncertainty values for each AU Value. In some embodiments, the uncertainty values obtained using the AU prediction model-1 122 may be used thereafter to fuse AU Regressed data predicted from AU Prediction Model-2 124 to predict much accurate action unit values.

In some embodiments, the AU prediction model-2 124 may take the generated frontal facial image(s) of the subject as an input. The final projection vector formed by the AU prediction model-1 122 may be used to regress AU values and uncertainty values corresponding to each AU value. In some embodiments, the uncertainty values obtained using the AU prediction model-2 124 may be used thereafter to fuse AU Regressed data predicted from AU Prediction Model-2 124 to predict much accurate action unit values.

Further, the AU prediction and fusion module 239 may use an AU fusion model 126 that may receive the predicted AU values and corresponding uncertainty values from both AU prediction model-1 122 and AU prediction model-2 124. The AU fusion model 126 may fuse the predicted AU values received from both AU prediction model-1 122 and AU prediction model-2 124 to generate a single robust and accurate AU predicted vector. Further, the AU fusion model 126 may fuse the uncertainty values predicted from both AU prediction model-1 122 and AU prediction model-2 124. In some embodiments, each regressed AU value may be weighted inversely proportional to the uncertainty to fuse to a single value. AU value with high uncertainty may receive lower weight and vice versa.

In some embodiments, the expression coefficient module 241 may generate expression coefficients indicating an expression to be applied on an animated avatar selected by the subject, based on the predicted AU regressed data and the uncertainty values corresponding to each of the one or more AU values. In some embodiments, for generating the expression coefficients, the expression coefficient module 241 may initially include predicting one or more new AU values by fusing the AU regressed data with the uncertainty values. The one or more new AU values may have an accuracy higher than an accuracy of the one or more AU values. Thereafter, the expression coefficient module 241 may determine the expression coefficients indicating expressions to be applied on the animated avatar selected by the subject, based on the one or more new AU values, using a blendshape co-efficient conversion model.

In some embodiments, the animated avatar generation module 243 may generate an expressive animated avatar by applying the expression corresponding to the expression coefficients on the animated avatar selected by the subject.

In some embodiments, the HMD device 102 may switch between a first mode and a second mode of generating avatars based on a user input. The first mode corresponds to generating the realistic avatar of the subject as described under FIG. 2A and the second mode corresponds to generating the expressive animated facial avatar as described under FIG. 2B.

In some embodiments, prior to the real-time operation of generating the realistic facial avatar of the subject, at the time of data annotation, the present disclosure may include using one or more image capturing devices such as IR cameras, RGB cameras and the like, to capture a complete view of the subject's face when the subject is not wearing the HMD device 102. In one or more examples, there may be three cameras arranged at three different angles to the subject. For instance, one camera may be in the center of the HMD device 102 (e.g., 0 degree), a second camera may be on the right side at a 30 degree angle, and a third camera may be on the left at a −30 degree angle. The subject may be aligned with a center camera. The image capturing module 223 may further synchronize each of these cameras before capturing the data of subject and start capturing session from each of the three synchronized cameras. The process of capturing the images may continue for different kinds of expressions. The captured images may be provided for 3D mesh generation, texture generation and the like, which are explained in detail in earlier parts of the disclosure. Further, as part of data annotation, the present disclosure includes storing data associated with each of the captured images such as camera position, rotation values, field of view, generated 3D mesh, generated texture, and the like. Thereafter, the present disclosure discloses generating perspective images based on each of the captured images, such as a left eye perspective, a right eye perspective, a left face perspective and a right face perspective for various expressions captured in the images. Each of the perspectives is further saved. In some embodiments, if the captured images are RGB images, the present disclosure discloses transferring domain/style on the RGB images to bring them in line with the IR images. FIG. 2D shows generation of a 3D mesh and texture based on captured images, and creating a virtual image by wrapping the texture on to the 3D mesh. Thereafter, FIG. 2D also shows generation of synthetic perspective images based on the generated virtual image by simulating virtual camera and positioning as placed in the HMD (e.g., Unity Perspectives). Thereafter, domain transfer is performed on the perspective images, where data is output for training. In this manner, automatic data collection and annotation is performed, which is used for training the AI/ML models prior to generation of the realistic facial avatar and animated facial avatar in real-time.

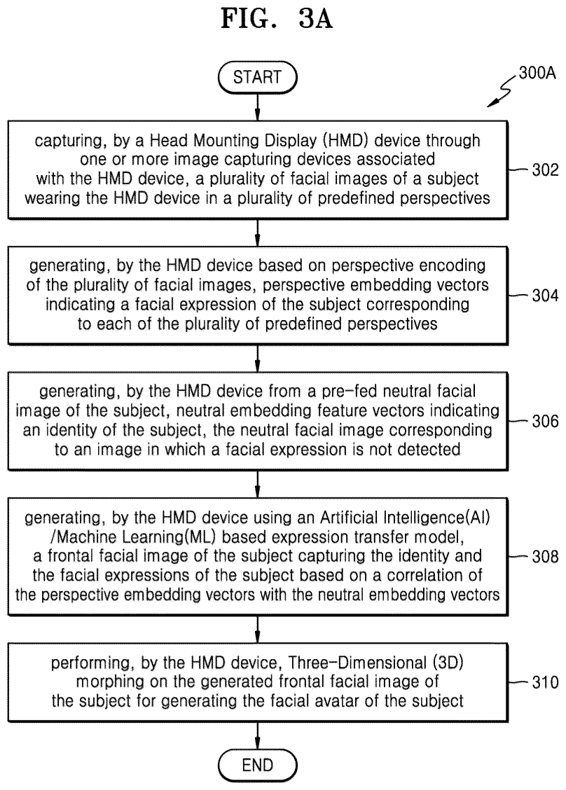

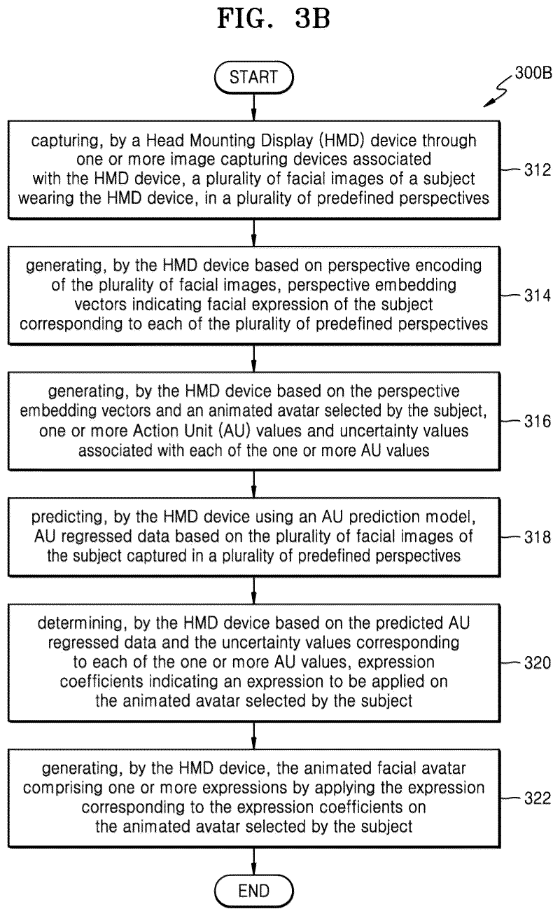

FIG. 3A depicts a flowchart illustrating a method of generating a realistic facial avatar 132 of a subject, in accordance with some embodiments of the present disclosure.

As illustrated in the FIG. 3A, the method 300a includes one or more operations illustrating the method 300a of generating a realistic facial avatar of a subject. The method 300a may be described in the general context of computer executable instructions. Generally, computer executable instructions can include routines, programs, objects, components, data structures, procedures, modules, and functions, which perform functions or implement abstract data types.

At operation 302, the method (300a) includes capturing, by a Head Mounting Display (HMD) device (102) through one or more image capturing devices associated with the HMD device, a plurality of facial images of a subject wearing the HMD device 102, in a plurality of predefined perspectives.

At operation 304, the method (300a) includes generating, by the HMD device (102) based on perspective encoding of the plurality of facial images, perspective embedding vectors indicating a facial expression of the subject corresponding to each of the plurality of predefined perspectives.

At operation 306, the method (300a) includes generating, by the HMD device (102) from a pre-fed neutral facial image of the subject, neutral embedding feature vectors indicating an identity of the subject.

At operation 308, the method (300a) includes generating, by the HMD device (102) using an Artificial Intelligence (AI)/Machine Learning (ML) based expression transfer model, a frontal facial image of the subject capturing the identity and the facial expressions of the subject based on a correlation of the perspective embedding vectors with the neutral embedding vectors.

At operation 310, the method (300a) includes performing, by the HMD device, Three Dimensional (3D) morphing on the generated frontal facial image of the subject for generating the facial avatar of the subject.

FIG. 3B depicts a flowchart illustrating a method of generating an animated facial avatar 132 of a subject, in accordance with some embodiments of the present disclosure.

As illustrated in the FIG. 3B, the method 300b includes one or more operations illustrating the method 300b of generating an animated facial avatar of a subject. The method 300b may be described in the general context of computer executable instructions. Generally, computer executable instructions can include routines, programs, objects, components, data structures, procedures, modules, and functions, which perform functions or implement abstract data types.

At operation 312, the method (300b) includes capturing, by a Head Mounting Display (HMD) device 102 through one or more image capturing devices associated with the HMD device 102, a plurality of facial images of a subject wearing the HMD device 102, in a plurality of predefined perspectives.

At operation 314, the method (300b) includes generating, by the HMD device 102 based on perspective encoding of the plurality of facial images, perspective embedding vectors indicating facial expression of the subject corresponding to each of the plurality of predefined perspectives.

At operation 316, the method (300b) includes generating, by the HMD device 102 based on the perspective embedding vectors and an animated avatar selected by the subject, one or more Action Unit (AU) values and uncertainty values associated with each of the one or more AU values.

At operation 318, the method (300b) includes predicting, by the HMD device 102 using an AU prediction model, AU regressed data based on the plurality of facial images of the subject captured in a plurality of predefined perspectives.

At operation 320, the method (300b) includes determining, by the HMD device 102 based on the predicted AU regressed data and the uncertainty values corresponding to each of the one or more AU values, expression coefficients indicating an expression to be applied on the animated avatar selected by the subject. In some embodiments, to determine the expression coefficients, the HMD device 102 may predict one or more new AU values by fusing the AU regressed data with the uncertainty values. The one or more new AU values have an accuracy higher than an accuracy of the one or more AU values. Thereafter, the HMD device 102 may determine the expression coefficients based on the one or more new AU values, using a blendshape co-efficient conversion model

At operation 322, the method (300b) includes generating, by the HMD device 102, the animated facial avatar comprising one or more expressions by applying the expression corresponding to the expression coefficients on the animated avatar selected by the subject.

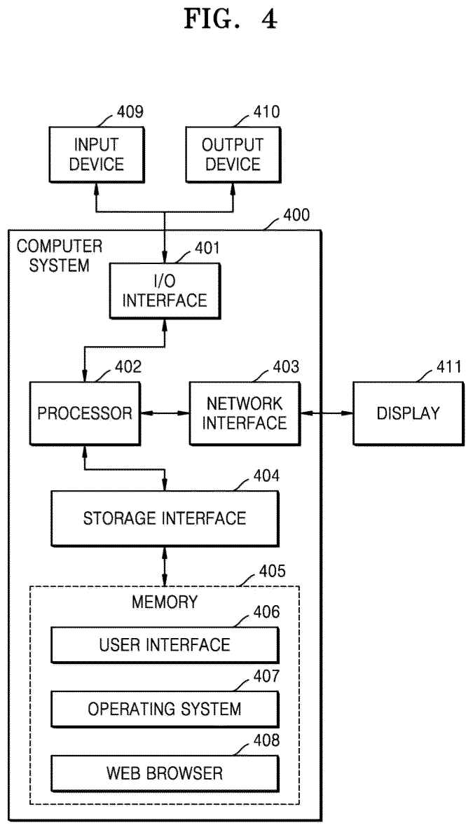

FIG. 4 illustrates a block diagram of an exemplary computer system 400 for implementing embodiments consistent with the present disclosure. In some embodiments, the exemplary computer system 400 may be a Head Mounting Display (HMD) device 102 used for generating a realistic facial avatar 132 of a subject. In some embodiments, the HMD the exemplary computer system 400 may be the HMD device 102 used to generate an animated facial avatar of the subject. The exemplary computer system 400 may comprise a Central Processing Unit 402 (also referred as “CPU” or “processor”). The processor 402 may comprise at least one data processor. The processor 402 may include specialized processing units such as integrated system (bus) controllers, memory management control units, floating point units, graphics processing units, digital signal processing units, etc. The processor 402 may be used to realize the processor 201 and 232 described in FIGS. 2A and 2B.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the exemplary computer system 400 may communicate with one or more I/O devices. For example, the input device 409 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 410 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 409 includes, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web browser 408 etc. In some embodiments, the exemplary computer system 400 may store user/application data, such as, the data, variables, records, etc., as described in this disclosure. Such databases may be implemented as fault-tolerant, relational, scalable, secure databases such as Oracle® or Sybase®. The memory 405 may be used to realize the memory 203 described in FIG. 4. The memory 405 may be communicatively coupled to the processor 402. The memory 405 stores instructions, executable by the one or more processors 402, which, on execution, may cause the processor 402 to generate a realistic facial avatar or an animated facial avatar on a display 411.

The operating system 407 may facilitate resource management and operation of the exemplary computer system 400. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like.

In some embodiments, the exemplary computer system 400 may implement the web browser 408 stored program component. The web browser 408 may be a hypertext viewing application, for example MICROSOFT® INTERNET EXPLORER™, GOOGLER CHROME™⁰, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX™, DHTML™, ADOBE® FLASH™, JAVASCRIPT™, JAVA™, Application Programming Interfaces (APIs), etc. In some embodiments, the exemplary computer system 400 may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the exemplary computer system 400 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

In the present disclosure, the HMD device generates the realistic facial avatar or an animated facial avatar based on images of different perspectives i.e., left eye perspective, left face perspective, right eye perspective and right face perspective captured through one or more image capturing devices positioned in the HMD device in a manner that capture the different perspectives effectively. Hence, this ensures enhanced way of capturing the expressions for the realistic facial images or animated facial images, and helps in achieving accurate representation of the subject's face, irrespective of the placement of the HMD.

Further, the present disclosure provides a hybrid approach that enables the user to generate both realistic facial avatar and animated facial avatar. Therefore, the present disclosure provides the user flexibility to switch between the generation of realistic facial avatar or an animated facial avatar. Also, such a hybrid approach enables the user the choice to preserve their identity when required using an animated avatar or use their realistic avatar in other scenarios.

The present disclosure provides a lightweight architecture that enables switching seamlessly between the realistic facial avatar and animated facial avatar of user's choice, due to light weight architecture designed to execute and seamlessly to support both the modes of generation.

Further, the AI/ML models used in the present disclosure are trained based on geometry of facial features, texture and IR images of users of various ethnicities and skin colors, thereby enabling effective face tracking, and generation of accurate realistic facial avatar or animated facial avatar for any ethnicity or skin color of the subject.

In the present disclosure, the AI/ML models are trained on IR images captured via IR cameras. Therefore, the present disclosure fills the domain gap between HMD perspective images and the training data which makes the face tracking effective despite different style and distortions of the IR images compared to normal RGB or grayscale images.

Therefore, overall, the present disclosure provides an improvised method of generating a realistic and animated facial avatar of a subject.

The present disclosure may help depict true-to-life facial expressions in the facial avatar generated using the HMD device. The present disclosure is configured to transfer realistic facial expressions onto the realistic facial avatar to help enhance interactions in virtual environments. The present disclosure is configured to enhance gaming experiences by enabling transfer of facial expressions onto custom made special characters. The present disclosure may be able to see its application in presentation coaching, customer service management, workplace etiquette, training and the like and enables users to track and improve their emotional preparedness.

In light of the technical advancements provided by the disclosed method and the control module, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “one or more embodiments”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of one or more embodiments with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is, therefore, intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Referral number | Description |
|---|---|
| 102 | HMD device |
| 104 | Neutral Face |
| 105 | Left eye perspective |
| 106 | Right eye perspective |
| 107 | Left face perspective |
| 108 | Right face perspective |
| 110 | Perspective encoder |
| 111 | Left face embedding |
| 112 | Left eye embedding |
| 113 | Right face embedding |
| 114 | Right eye embedding |
| 116 | AI/ML based expression transfer model |
| 118 | 3D coefficient prediction model |
| 120 | Module switch |
| 122 | AU prediction model-1 |
| 124 | AU prediction model-2 |
| 126 | AU fusion model |
| 128 | Blend shape co-efficient conversion |
| 130 | Unity application |
| 132 | Realistic Facial Avatar |
| 134 | Animated facial Avatar |
| 135-138 | Image capturing devices |
| 201 | Processor |
| 202 | Memory |
| 203 | I/O interface |
| 205 | Data |
| 209 | Image data |
| 211 | Perspective Embedding Vector data |
| 213 | Neutral Embedding Vector data |
| 215 | Frontal facial image data |
| 217 | Realistic facial avatar data |
| 219 | Other data for realistic facial avatar |
| 223 | Image Capturing module |
| 225 | Embedding vector generation module |
| 227 | Frontal Facial image generation module |
| 229 | Facial avatar generation module |
| 231 | Other modules for realistic facial avatar |
| 232 | Action Units data |
| 233 | Blendshape coefficients data |
| 235 | Animated facial avatar data |
| 237 | Other data for animated facial avatar |
| 239 | AU prediction and fusion module |
| 241 | Expression co-efficient module |
| 243 | Animated avatar generation module |
| 245 | Other modules for animated facial avatar |
| 400 | Exemplary computer system |
| 401 | I/O interface of an exemplary computer system |
| 402 | Processor of an exemplary computer system |
| 403 | Network interface of an exemplary computer system |
| 404 | Storage interface of an exemplary computer system |
| 405 | Memory of an exemplary computer system |
| 406 | User interface of an exemplary computer system |
| 407 | Operating system of an exemplary computer system |
| 408 | Web browser of an exemplary computer system |
| 409 | Input device of an exemplary computer system |
| 410 | Output device of an exemplary computer system |
| 411 | Display of an exemplary computer system |

What is claimed is:

1. A method of generating a facial avatar of a subject, the method comprising:
capturing, by a Head Mounting Display (HMD) device through one or more image capturing devices associated with the HMD device, a plurality of facial images of a subject wearing the HMD device in a plurality of predefined perspectives;
generating, by the HMD device based on perspective encoding of the plurality of facial images, perspective embedding vectors indicating a facial expression of the subject corresponding to each of the plurality of predefined perspectives;
generating, by the HMD device from a pre-fed neutral facial image of the subject, neutral embedding feature vectors indicating an identity of the subject, the neutral facial image corresponding to an image in which a facial expression is not detected;
generating, by the HMD device using an Artificial Intelligence (AI)/Machine Learning (ML) based expression transfer model, a frontal facial image of the subject capturing the identity and the facial expressions of the subject based on a correlation of the perspective embedding vectors with the neutral embedding vectors; and
performing, by the HMD device, three-Dimensional (3D) morphing on the generated frontal facial image of the subject for generating the facial avatar of the subject.

2. The method as claimed in claim 1 further comprises:
generating, by the HMD device, a latent vector indicating a style of the subject by performing affine transformation on the neutral facial image of the subject; and
generating, by the HMD device, the frontal facial image of the subject capturing the identity, facial expressions, and style of the subject based on a correlation of the latent vector with the perspective embedding vectors and the neutral embedding vectors.

3. The method as claimed in claim 1, wherein the capturing the plurality of facial images comprises capturing at least a part of a face of the subject in each of the plurality of facial images in the plurality of predefined perspectives.

4. The method as claimed in claim 1, wherein the plurality of predefined perspectives comprises a left eye perspective, a left face perspective, a right eye perspective, and a right face perspective.

5. The method as claimed in claim 1, wherein the one or more image capturing devices are synchronized and aligned to capture the plurality of facial images in the plurality of predefined perspectives.

6. The method as claimed in claim 1, wherein the perspective embedding vectors corresponding to each of the plurality of predefined perspectives are generated using a first deep neural network model based on a contrastive loss determination that determines a similarity score between two different vectors, wherein the first deep neural network model creates a plurality of expression clusters by grouping the perspective embedding vectors that indicate similar expressions of the subject.

7. The method as claimed in claim 1, wherein the generating the frontal facial image of the subject using the AI/ML based expression transfer model comprises:
generating a first frontal facial image of the subject based on a correlation of first perspective embedding vectors from the perspective embedding vectors with the neutral embedding vectors, wherein a resolution of the generated first frontal facial image is a first resolution resulting in a first total loss higher than a predefined threshold loss;
generating a second frontal facial image of the subject using at least a part of the generated first frontal facial image, and correlation of second perspective embedding vectors from the embedding vectors with the neutral embedding vectors, wherein a resolution of the generated second frontal facial image is a second resolution higher than the first resolution, resulting in a second total loss higher than the predefined threshold loss and lower than the first total loss;
generating one or more subsequent frontal facial images of the subject using at least a part of the first frontal facial image or the second frontal facial image until a final total loss is lower than the predefined threshold loss, wherein each of the one or more subsequent frontal facial images is successively higher in resolution than a corresponding preceding frontal facial image; and
determining a final frontal facial image from the one or more subsequent frontal facial images resulting in the final total loss lower than the predefined threshold loss as the frontal facial image of the subject.

8. A method of generating an animated facial avatar of a subject, the method comprising:
capturing, by a Head Mounting Display (HMD) device through one or more image capturing devices associated with the HMD device, a plurality of facial images of a subject wearing the HMD device, in a plurality of predefined perspectives;
generating, by the HMD device based on perspective encoding of the plurality of facial images, perspective embedding vectors indicating facial expression of the subject corresponding to each of the plurality of predefined perspectives;
generating, by the HMD device based on the perspective embedding vectors and an animated avatar selected by the subject, one or more Action Unit (AU) values and uncertainty values associated with each of the one or more AU values;
predicting, by the HMD device using an AU prediction model, AU regressed data based on the plurality of facial images of the subject captured in a plurality of predefined perspectives;
determining, by the HMD device based on the predicted AU regressed data and the uncertainty values corresponding to each of the one or more AU values, expression coefficients indicating an expression to be applied on the animated avatar selected by the subject; and
generating, by the HMD device, the animated facial avatar comprising one or more expressions by applying the expression corresponding to the expression coefficients on the animated avatar selected by the subject.

9. The method as claimed in claim 8, wherein the determining the expression coefficients comprises:
predicting, by the HMD device, one or more new AU values by fusing the AU regressed data with the uncertainty values, wherein the one or more new AU values have an accuracy higher than an accuracy of the one or more AU values; and
determining, by the HMD device, based on the one or more new AU values using a blendshape co-efficient conversion model, the expression coefficients indicating expressions to be applied on the animated avatar selected by the subject.

10. The method according to claim 8 further comprising:
switching, by the HMD device based on a user input, between a first mode and a second mode of generating avatars based on a user input, wherein the first mode corresponds to generating a non-animated facial avatar of the subject and the second mode corresponds to generating the animated facial avatar of the subject.

11. A Head Mounting Display (HMD) device for generating a facial avatar of a subject, the HMD device comprising:
at least one processor;
memory, communicatively coupled to the at least one processor, wherein the memory stores one or more instructions,
wherein the one or more instructions, when executed by the at least one processor individually or collectively, cause the electronic device to:
capture, through one or more image capturing devices associated with the HMD device, a plurality of facial images of a subject wearing the HMD device in a plurality of predefined perspectives;
generate, based on perspective encoding of the plurality of facial images, perspective embedding vectors indicating facial expression of the subject corresponding to each of the plurality of predefined perspectives;
generate, from a pre-fed neutral facial image of the subject, neutral embedding feature vectors indicating identity of the subject, the neutral facial image corresponding to an image in which a facial expression is not detected;
generate, using an Artificial Intelligence (AI)/Machine Learning (ML) based expression transfer model, a frontal facial image of the subject capturing the identity and the facial expressions of the subject based on correlation of the perspective embedding vectors with the neutral embedding vectors; and
perform by the HMD device, three dimensional (3D) morphing on the generated frontal facial image of the subject for generating the facial avatar of the subject.

12. The HMD device as claimed in claim 11, wherein the processor is configured to:
generate a latent vector indicating a style of the subject by performing affine transformation on the neutral facial image of the subject; and
generate the frontal facial image of the subject capturing the identity, facial expressions and style of the subject based on a correlation of the latent vector with the perspective embedding vectors and the neutral embedding vectors.

13. The HMD device as claimed in claim 11, wherein the capture of the plurality of facial images comprises capturing at least a part of a face of the subject in each of the plurality of facial images in the plurality of predefined perspectives.

14. The HMD device as claimed in claim 11, wherein the plurality of predefined perspectives comprises a left eye perspective, a left face perspective, a right eye perspective, and a right face perspective.

15. The HMD device as claimed in claim 11, wherein the processor synchronizes and aligns the one or more image capturing devices to capture the plurality of facial images in the plurality of predefined perspectives.

16. The HMD device as claimed in claim 11, wherein the processor generates the perspective embedding vectors corresponding to each of the plurality of predefined using a first deep neural network model based on a contrastive loss determination that determines a similarity score between two different vectors, wherein the first deep neural network model creates a plurality of expression clusters by grouping the perspective embedding vectors that indicate similar expressions of the subject.

17. The HMD device as claimed in claim 11, wherein to generate the frontal facial image of the subject using the AI/ML based expression transfer model, the processor is configured to:
generate a first frontal facial image of the subject based on a correlation of first perspective embedding vectors from the perspective embedding vectors with the neutral embedding vectors, wherein a resolution of the generated first frontal facial image is a first resolution resulting in a first total loss higher than a predefined threshold loss;
generate a second frontal facial image of the subject using at least a part of the generated first frontal facial image, and correlation of second perspective embedding vectors from the perspective embedding vectors with the neutral embedding vectors, wherein a resolution of the generated second frontal facial image is a second resolution higher than the first resolution, resulting in a second total loss higher than the predefined threshold loss and lower than the first total loss;
generate one or more subsequent frontal facial images of the subject using at least a part of the first frontal facial image or the second frontal facial image until a final total loss is lower than the predefined threshold loss, wherein each of the one or more subsequent frontal facial images is successively higher in resolution than a corresponding preceding frontal facial image; and
determining a final frontal facial image resulting in the final total loss lower than the predefined threshold loss as the frontal facial image of the subject.

18. A Head Mounting Display (HMD) device for generating an animated facial avatar of a subject, the HMD device comprising:
at least one processor;
memory, communicatively coupled to the at least one processor, wherein the memory stores one or more instructions,
wherein the one or more instructions, when executed by the at least one processor individually or collectively, cause the electronic device to:
capture, through one or more image capturing devices associated with the HMD device, a plurality of facial images of a subject wearing the HMD device in a plurality of predefined perspectives;
generate, based on perspective encoding of the plurality of facial images, perspective embedding vectors indicating facial expression of the subject corresponding to each of the plurality of predefined perspectives;
generate, based on the perspective embedding vectors and an animated avatar selected by the subject, one or more Action Unit (AU) values and uncertainty values associated with each of the one or more AU values;
predict, using an AU prediction model, AU regressed data based on the plurality of facial images of the subject captured in a plurality of predefined perspectives;
determine, based on the predicted AU regressed data and the uncertainty values corresponding to each of the one or more AU values, expression coefficients indicating an expression to be applied on the animated avatar selected by the subject; and
generate the animated facial avatar comprising one or more expressions by applying the expression corresponding to the expression coefficients on the animated avatar selected by the subject.

19. The HMD device as claimed in claim 18, wherein to determine the expression coefficients, the processor is configured to:
predict one or more new AU values by fusing the AU regressed data with the uncertainty values, wherein the one or more new AU values have an accuracy higher than an accuracy of the one or more AU values; and
determine, based on the one or more new AU values, using a blendshape co-efficient conversion model, the expression coefficients indicating expressions to be applied on the animated avatar selected by the subject.

20. The HMD device as claimed in claim 18, wherein the processor is further configured to switch, based on a user input, between a first mode and a second mode of generating avatars based on a user input, wherein the first mode corresponds to generating a non-animated facial avatar of the subject, and the second mode corresponds to generating the animated facial avatar.
